(19) United States
(12) Patent Application Publication
(10) Pub. No.: US 2025/0077010 A1
(43) Pub. Date: Mar. 6, 2025

(54) DISPLAY PANEL AND DISPLAY DEVICE

(71) Applicant: Xiamen Tianma Optoelectronics Co., Ltd., Xiamen (CN)

(72) Inventors: Guangya WU, Xiamen (CN); Zongcai DING, Xiamen (CN); Xiaohe LI, Xiamen (CN)

(21) Appl. No.: 18/948,422

(22) Filed: Nov. 14, 2024

(30) Foreign Application Priority Data
Aug. 30, 2024 (CN) 202411215569.X

(51) Int. Cl. G06F 3/041

(52) U.S. Cl. CPC G06F 3/0412

(57) ABSTRACT

A display panel and a display device, including scan lines and data lines intersecting each other to define sub-pixel regions. At least one sub-pixel is provided in a respective sub-pixel region and includes a first electrode including two domain portions having different domain orientations along extending direction of the scan line. Extending direction of the touch line is the same as that of the domain boundaries of a column of first electrodes, and a vertical projection of the touch line overlaps with a vertical projection of the domain boundaries of a column of first electrodes onto the substrate. The touch electrode is electrically connected to the touch line via a first through-hole arranged adjacent to the scan line, and a vertical projection of the first through-hole overlaps with a vertical projection of the touch line onto the substrate. The display and touch effect of the display panel is improved.

### CROSS-REFERENCE TO RELATED APPLICATIONS

The present application claims priority to Chinese Patent Application No. 202411215569.X, filed on Aug. 30, 2024, the content of which is incorporated herein by reference in its entirety.

### TECHNICAL FIELD

The present disclosure relates to the technical field of display, and in particular, to a display panel and a display device.

### BACKGROUND

With the development of display technology, a touch display panel has been widely accepted and used. The touch display panel adopts an embedded touch technology to integrate a touch panel and a display panel, so that the display panel simultaneously have both display and touch input sensing functions, and is widely applied to various electronic products such as mobile phones, televisions, tablet computers, and desktop computers, becoming the mainstream in display devices.

For an existing in cell touch panel, a touch sensor function is embedded into a display screen, making the display screen thinner and lighter. However, for the existing in cell touch panel, a space between a data line and a touch line is relatively small, thereby generating a parasitic capacitance. The presence of the parasitic capacitance may affect the display performance and touch sensitivity of the in cell touch panel.

### SUMMARY

In order to solve the above-mentioned technical problems or at least partially solve the above-mentioned technical problems, the present disclosure provides a display panel and a display device, which effectively improve the display effect and touch effect of the display panel.

In an aspect, an embodiment of the present disclosure provides a display panel, including an array substrate including: scan lines and data lines intersecting each other in an insulated manner to define sub-pixel regions; sub-pixels arranged in an array, wherein at least one of the sub-pixels is provided within a respective one of the sub-pixel regions, each of the sub-pixels includes a first electrode, the first electrodes include two domain portions having different domain orientations along an extending direction of one of the scan lines, and domain boundaries of a column of first electrodes are arranged at a same straight line; touch lines, wherein an extending direction of one of the touch lines is the same as an extending direction of the domain boundaries of a column of first electrodes, and a vertical projection of the one of the touch lines onto the array substrate at least partially overlaps with a vertical projection of the domain boundaries of the column of first electrodes onto the array substrate; and touch electrodes, wherein one of the touch electrodes is electrically connected to at least one of the touch lines via a first through-hole, a vertical projection of the first through-hole onto the array substrate at least partially overlaps with a vertical projection of the touch line onto the array substrate, and the first through-hole is arranged adjacent to the scan line.

In another aspect, an embodiment of the present disclosure provides a display device, including a display panel including an array substrate. The array substrate includes: scan lines and data lines intersecting each other in an insulated manner to define sub-pixel regions; sub-pixels arranged in an array, wherein at least one of the sub-pixels is provided within a respective one of the sub-pixel regions, each of the sub-pixels includes a first electrode, the first electrodes include two domain portions having different domain orientations along an extending direction of one of the scan lines, and domain boundaries of a column of first electrodes are arranged at a same straight line; touch lines, wherein an extending direction of one of the touch lines is the same as an extending direction of the domain boundaries of a column of first electrodes, and a vertical projection of the one of the touch lines onto the array substrate at least partially overlaps with a vertical projection of the domain boundaries of the column of first electrodes onto the array substrate; and touch electrodes, wherein one of the touch electrodes is electrically connected to at least one of the touch lines via a first through-hole, a vertical projection of the first through-hole onto the array substrate at least partially overlaps with a vertical projection of the touch line onto the array substrate, and the first through-hole is arranged adjacent to the scan line.

### BRIEF DESCRIPTION OF DRAWINGS

The drawings herein, which are incorporated in and constitute a part of this specification, illustrate embodiments in accordance with the present disclosure, and together with the specification, serve to explain principles of the present disclosure.

In order to more clearly illustrate the embodiments of the present disclosure or the technical solutions in the related art, the drawings, which are intended to be used in the description of the embodiments or the prior art, are briefly described as below, and it will be apparent that other drawings may be obtained by those skilled in the art according to these drawings without paying any creative efforts.

FIG. 1 is a schematic plan view of a display panel according to an embodiment of the present disclosure;

FIG. 2 is an enlarged view of a part A in the display panel shown in FIG. 1;

FIG. 3 is a cross-sectional view of the display panel shown in FIG. 2 along B-B′;

FIG. 4 is another enlarged view of a part A in the display panel shown in FIG. 1;

FIG. 5 is yet another enlarged view of a part A in the display panel shown in FIG. 1;

FIG. 6 is an enlarged view of a part C in the display panel shown in FIG. 1;

FIG. 7 is another enlarged view of a part C in the display panel shown in FIG. 1;

FIG. 8 is yet another enlarged view of a part C in the display panel shown in FIG. 1;

FIG. 9 is an enlarged view of a part J in the display panel shown in FIG. 1;

FIG. 10 is yet another enlarged view of a part A in the display panel shown in FIG. 1;

FIG. 11 is a cross-sectional view of the display panel shown in FIG. 10 along E-E′;

FIG. 12 is yet another enlarged view of a part C in the display panel shown in FIG. 1;

FIG. 13 is another enlarged view of a part J in the display panel shown in FIG. 1;

FIG. 14 is a cross-sectional view of the display panel shown in FIG. 2 along F-F′;

FIG. 15 is a cross-sectional view of the display panel shown in FIG. 10 along G-G′;

FIG. 16 is a cross-sectional view of the display panel shown in FIG. 6 along H-H′; and

FIG. 17 is a schematic plan view of a display device according to an embodiment of the present disclosure.

### DESCRIPTION OF EMBODIMENTS

In order to better illustrate purposes, features and advantages of the present disclosure, the solutions of the present disclosure will be further described below. It should be noted that the embodiments of the present disclosure and the features in the embodiments may be combined with each other without conflict.

In the following description, various specific details are set forth to better illustrate the present disclosure, but the present disclosure may be implemented in other manners different from those described herein. It is apparent that the embodiments in the specification are only some of, rather than all of the embodiments of the present disclosure.

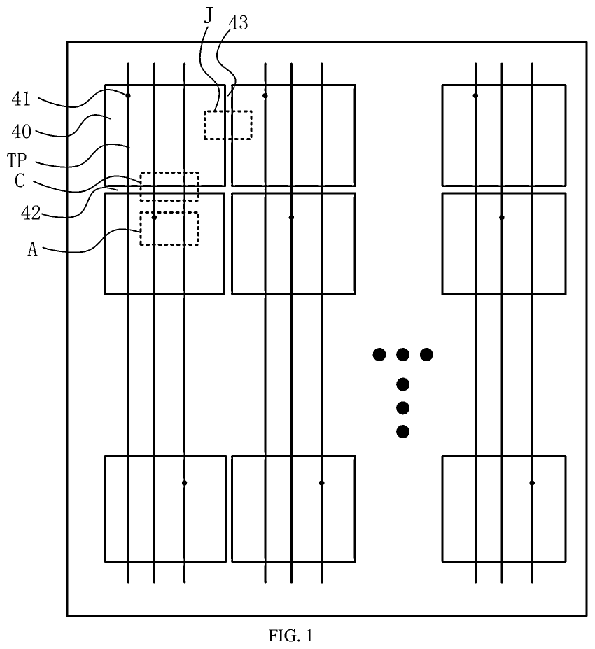

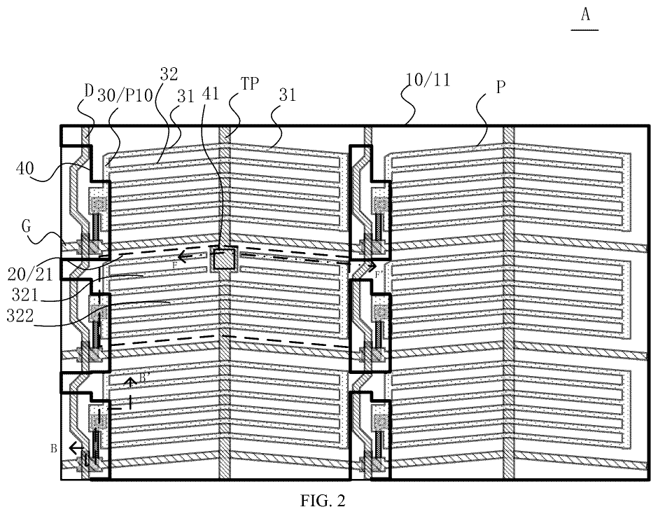

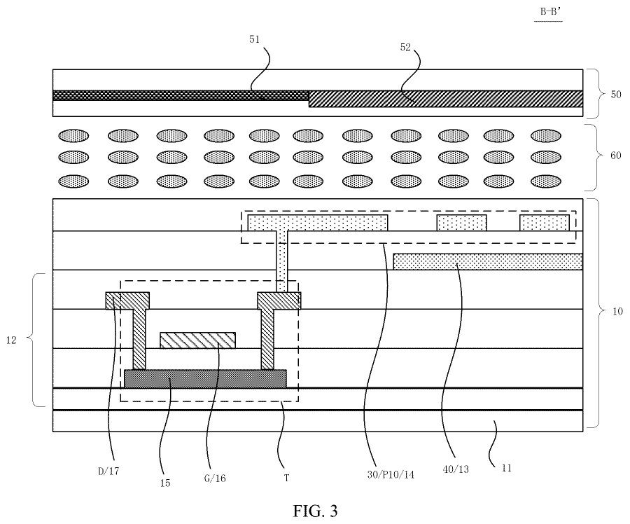

FIG. 1 is a schematic plan view of a display panel according to an embodiment of the present disclosure, FIG. 2 is an enlarged view of a part A in the display panel shown in FIG. 1, and FIG. 3 is a sectional view of the display panel shown in FIG. 2 along B-B′. Referring to FIGS. 1-3, an embodiment of the present disclosure provides a display panel, including: an array substrate 10.

The array substrate 10 includes: multiple scan lines G and multiple data lines D intersecting each other in an insulated manner to define multiple sub-pixel regions 20; multiple sub-pixels P arranged in an array; multiple touch lines TP; and multiple touch electrodes 40.

At least one sub-pixel P is provided in one of the sub-pixel regions 20. The sub-pixel P includes a first electrode 30. The first electrode 30 includes two domain portions 31 having different domain orientations along an extending direction of the scan lines G. The domain boundaries of a column of first electrodes 30 are located at a same straight line.

An extending direction of the touch line TP is the same as an extending direction of the domain boundaries of a column of first electrodes 30, and a vertical projection of the touch line TP onto the array substrate 10 at least partially overlaps with a vertical projection of the domain boundaries of a column of first electrodes 30 onto the array substrate 10.

The touch electrode 40 is electrically connected to at least one touch line TP via a first through-hole 41, a vertical projection of the first through-hole 41 onto the array substrate 10 at least partially overlaps with a vertical projection of the touch line TP onto the array substrate 10, and the first through-hole 41 is arranged adjacent to the scan line G.

In an example, the display panel according to an embodiment of the present disclosure may be a liquid crystal display panel. The display panel includes the array substrate 10 and a color filter substrate 50 arranged opposite to the array substrate 10. A liquid crystal layer 60 is provided between the array substrate 10 and the color filter substrate 50, and the liquid crystal layer 60 includes liquid crystal molecules. It can be understood that, in this embodiment, the liquid crystal molecules of the liquid crystal layer 60 are positive liquid crystals as an example for illustration. In some other alternative embodiments, the liquid crystal molecules of the liquid crystal layer 60 may be negative liquid crystals. During implementation, it can be selected and configured according to actual requirements. When no electric power is applied, that is, when no driving electric field is applied, the liquid crystal molecules are in a direction parallel to the display panel. When electric power is applied, that is, when a driving electric field is applied, long axes of positive liquid crystal molecules are deflected along a direction of the electric field, and long axes of negative liquid crystal molecules are deflected along a direction perpendicular to the direction of the electric field. During implementation, it can be configured according to actual requirements.

The array substrate 10 includes multiple scan lines G and multiple data lines D which intersect each other in an insulated manner to define multiple sub-pixel regions 20, and the sub-pixel region 20 can be understood as a block-shaped region. The array substrate 10 further includes multiple sub-pixels P arranged in an array. The sub-pixel P corresponds to the sub-pixel region 20 and is located in the sub-pixel region 20 corresponding thereto. At least one sub-pixel P is arranged in one sub-pixel region 20.

The array substrate 10 further includes multiple touch lines TP and multiple touch electrodes 40. The touch electrode 40 is electrically connected to at least one touch line TP via a first through-hole 41. The touch electrode 40 is reused as a common electrode at a display stage of the display panel, and is reused as a touch electrode at a touch stage of the display panel. A touch signal is transmitted through the touch line TP, to realize a touch detection function. The touch electrode 40 may be formed by a transparent conductive material, such as Indium Tin Oxides (ITO) semiconductor transparent conductive film, which is not limited in this embodiment. The touch electrode 40 may have a block-shaped structure. It can be understood that an area of the touch electrode 40 having the block-shaped structure may be greater than an area of a single sub-pixel P, that is, one touch electrode 40 may correspond to more than one sub-pixel P. When the display panel performs touch detection, a detection capacitance is formed between a block-shaped touch electrode 40 and a common ground. When a touch subject, such as a finger, touches and detects the display panel, a capacitance formed between the finger and the detection capacitance is superimposed at the touch electrode 40, causing a change in a capacitance at a touch position, thereby obtaining a touch point coordinate based on the change in the capacitance, to complete the detection of the touch position. It can be understood that a touch detection principle of the display panel is not described in detail in this embodiment. During implementation, it can be understood by referring to a touch principle of an in cell touch display panel in the related art.

The sub-pixel P includes the first electrode 30. Along the extending direction of the scan line G, the first electrode 30 includes two domain portions 31 having different domain orientations. The domain boundaries of a column of first electrodes 30 are located at a same straight line. The extending direction of the touch line TP is the same as the extending direction of the domain boundaries of a column of first electrodes 30. The vertical projection of the touch line TP onto the array substrate 10 at least partially overlaps with the vertical projection of the domain boundaries of a column of first electrodes 30 onto the array substrate 10, that is, multiple touch lines TP are arranged corresponding to the domain boundaries of multiple columns of first electrodes 30. The touch line TP is arranged at a position corresponding to the domain boundaries of its corresponding column of first electrodes 30, so that a space between the touch line TP and the data line D is relatively large, which effectively reduces a parasitic capacitance between the touch line TP and the data line D, thereby improving the display effect and touch effect of the display panel.

Furthermore, the liquid crystal molecules in the liquid crystal layer 60 may have disordered alignment at a position corresponding to the domain boundaries of the first electrodes 30, thereby affecting the contrast of the display panel during display. The vertical projection of the touch line TP onto the array substrate 10 at least partially overlaps with the vertical projection of the domain boundaries of a column of first electrodes 30 onto the array substrate 10, that is, the touch line TP may be arranged at a position corresponding to domain boundaries of one column of first electrodes 30 corresponding to the touch line TP, so that the touch line TP can shield a region prone to disordered alignment, thereby effectively improving the contrast of the display panel during display, and thus improving the display effect of the display panel.

Meanwhile, the vertical projection of the first through-hole 41 onto the array substrate 10 at least partially overlaps with the vertical projection of the touch line TP onto the array substrate 10, so that the touch line TP is electrically connected to the touch electrode 40 via the first through-hole 41, and the touch line TP extends along an extending direction of the domain boundaries of one column of first electrodes 30 corresponding to the touch line TP, and there is no need for the touch line TP to be provided with a branch electrically connected to the touch electrode 40, thereby facilitating the reduction of a length of the touch line TP and improving an aperture ratio, and thus improving the display effect of the display panel.

For example, when arranging the touch line TP to be electrically connected to the touch electrode 40 via the first through-hole 41, a space between the first through-hole 41 and an adjacent scan line G may be arranged to be minimized, thereby facilitating reducing an influence of a light shielding portion 51 at a position corresponding to the first through-hole 41 on the aperture ratio, and facilitating improving the aperture ratio.

It should be noted that multiple touch lines TP may be arranged one-to-one corresponding to the domain boundaries of multiple columns of first electrodes 30, or the number of the touch lines TP may be set to be less than the number of the data lines D. In this case, the touch lines TP may be provided at the domain boundaries of only some columns of first electrodes 30, for example, a respective one touch signal line is provided at the domain boundaries of a column of first electrodes 30 spaced by n columns of sub-pixels P, and the details are not further described herein.

It can be understood that a structure of the display panel is only exemplarily drawn in the figures of the embodiments. During implementation, the structure of the display panel includes but is not limited to this, and may further include other structures capable of implementing display and touch functions, which may be understood with reference to a structure of the liquid crystal display panel in the related art, and details are not described herein in the embodiments.

Continuing to refer to FIGS. 1-3, in some alternative embodiments, the array substrate 10 further includes a first base substrate 11, an array layer 12, a first electrode layer 13, and a second electrode layer 14 arranged in sequence.

The scan lines G, the data lines D and the touch lines TP are arranged in the array layer 12.

The touch electrodes 40 are arranged in the first electrode layer 13.

The first electrodes 30 are arranged in the second electrode layer 14. The sub-pixel P includes a pixel electrode P10, and the first electrode 30 may be the pixel electrode P10. The pixel electrode P10 includes multiple electrode branches 32 connected to each other, and in a same pixel electrode P10, multiple electrode branches 32 are arranged along an extending direction of the data line D.

In an example, the array substrate 10 further includes a first base substrate 11 and an array layer 12 arranged at a side of the first base substrate 11, and the array layer 12 includes multiple metal film layers and an insulating layer arranged between the metal film layers. Each of the scan lines G, the data lines D and the touch lines TP is arranged in the metal film layer in the array layer 12. The array layer 12 further includes multiple thin film transistors T. Each of the gate electrodes, the source electrodes and the drain electrodes of the thin film transistors T is arranged in the metal film layer in the array layer 12, and the array layer 12 further includes an active layer 15. When the display panel according to an embodiment of the present disclosure performs displaying, the thin film transistor T serves as a turn on/off device of the sub-pixels P in the display panel, and is configured to transmit a pixel voltage signal to the pixel electrode P10 in a turn-on state. The gate electrode of the thin film transistor T is connected to the scan line G of the display panel, and is connected to a scan driving circuit (not shown) via the scan line G. The source electrode of the thin film transistor T is connected to the data line D, and is then connected to a driving chip or a flexible circuit board that is for providing a driving signal and subsequently bound to the display panel via the data line D. The drain electrode of the thin film transistor T is connected to the pixel electrode P10, and a data voltage signal is loaded to the pixel electrode P10 via the data line D, so that an electric field that drives the deflection of the liquid crystal molecules of the liquid crystal layer 60 is formed between the pixel electrode P10 and a common electrode, thereby controlling whether light is emitted or not by means of the deflection of the liquid crystal molecules, and achieving the display effect of the display panel. It can be understood that a display principle of the display panel is not described in detail in the embodiments. During implementation, it can be understood by referring to display principle of the liquid crystal display panel in the related art.

The array substrate 10 further includes a first electrode layer 13 and a second electrode layer 14 arranged at a side of the first electrode layer 13 away from the first base substrate 11, and the touch electrode 40 is arranged in the first electrode layer 13. When the display panel is at the display stage, the touch electrode 40 is configured to access a common voltage signal, that is, the touch electrode 40 can be reused as the common electrode. The first electrode 30 is arranged in the second electrode layer 14. The sub-pixel P includes a pixel electrode P10, and the first electrode 30 is the pixel electrode P10. In other words, the pixel electrode P10 is arranged in the second electrode layer 14, and the second electrode layer 14 may be understood as a pixel electrode layer. The touch electrode 40 is arranged between the first base substrate 11 and the pixel electrode P10. The touch electrode 40 may be designed as a block shape. Each pixel electrode P10 includes multiple electrode branches 32 connected to each other. In a same pixel electrode P10, the electrode branches 32 are arranged along the extending direction of the data line D, so that when the display panel is at the display stage, the electric field formed between the touch electrode 40 and the pixel electrode P10 may exit from a slit between the electrode branches 32, to drive the liquid crystal molecules of the liquid crystal layer 60 to deflect, thereby achieving the display effect of the display panel.

It should be noted that a shape of the pixel electrode is only exemplarily illustrated in the figures of the embodiments. During implementation, the shape of the pixel electrode includes but is not limited to this, and may also be other shape, which will not be described in detail herein.

Continuing to refer to FIGS. 1-3, in some alternative embodiments, the electrode branches 32 include a first electrode branch 321 and a second electrode branch 322.

In the first electrode branch 321, the two domain portions 31 are arranged at two sides of the first through-hole 41 along the extending direction of the scan line G, and a vertical projection of the two domain portions 31 onto the first base substrate 11 is discontinuous at a position corresponding to the vertical projection of the first through-hole 41 onto the first base substrate 11.

A vertical projection of the second electrode branch 322 onto the first base substrate 11 partially overlaps with the vertical projection of the touch line TP onto the first base substrate 11.

In an example, the vertical projection of the touch line TP onto the first base substrate 11 at least partially overlaps with the vertical projection of the domain boundaries of a column of first electrodes 30 onto the first base substrate 11. The touch electrode 40 is electrically connected to at least one touch line TP via the first through-hole 41. The vertical projection of the first through-hole 41 onto the first base substrate 11 at least partially overlaps with the vertical projection of the touch line TP onto the first base substrate 11, and the first through-hole 41 is arranged adjacent to the scan line G. In order to prevent the electrode branch 32 from affecting the arrangement of the first through-hole 41, in the first electrode branch 321 of the electrode branches 32 corresponding to the first through-hole 41, the two domain portions 31 are arranged at two sides of the first through-hole 41 along the extending direction of the scan lines G, and the vertical projection of the two domain portions 31 onto the first base substrate 11 is discontinuous at a position corresponding to the vertical projection of the first through-hole 41 onto the first base substrate 11, that is, the first electrode branch 321 is discontinuous at a position corresponding to the first through-hole 41, so that the vertical projection of the first electrode branch 321 onto the first base substrate 11 does not overlap with the vertical projection of the first through-hole 41 onto the first base substrate 11, and the first electrode branch 321 does not affect the arrangement of the first through-hole 41. When the touch electrode 40 arranged in the first electrode layer 13 is connected to the touch line TP arranged in the metal layer in the array layer 12 through a ridge located in the second electrode layer 14, the first electrode branch 321 is discontinuous at a position corresponding to the bridge, thereby preventing a short circuit between the electrode branch 32 and the bridge.

The vertical projection of the second electrode branch 322 of the electrode branches 32 onto the first base substrate 11 partially overlaps with the vertical projection of the touch line TP onto the first base substrate 11, that is, the vertical projection of the touch line TP onto the first base substrate 11 at least partially overlaps with the vertical projection of a junction of the two domain portions 31 in the second electrode branch 322 onto the array substrate 10, that is, the second electrode branch 322 of the electrode branches 32 does not need to be designed to be discontinuous at the position corresponding to the first through-hole 41, and the second electrode branch 322 does not affect the arrangement of the first through-hole 41.

In a part of the pixel electrodes P10, each electrode branch 32 does not affect the arrangement of the first through-hole 41, therefore, each electrode branch 32 in this part of the pixel electrodes P10 is the second electrode branch 322.

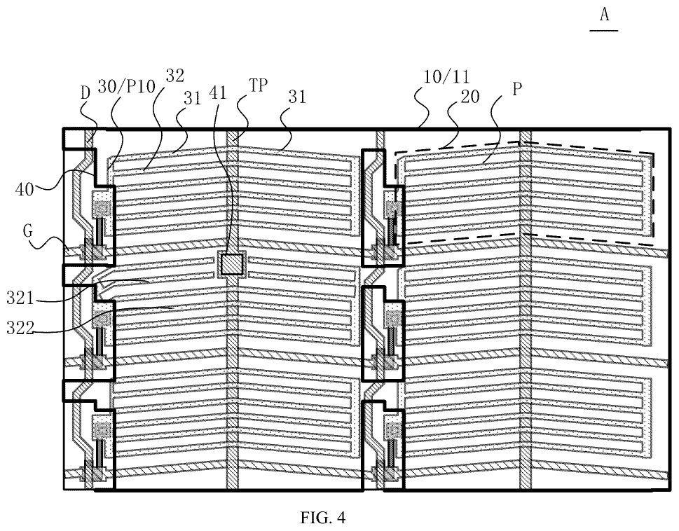

FIG. 4 is another enlarged view of a part A in the display panel shown in FIG. 1. Referring to FIG. 1 and FIG. 4, in some alternative embodiments, along the extending direction of the scan line G, a space between the domain portion 31 of the first electrode branch 321 and the data line D adjacent thereto is smaller than a space between the domain portion 31 of the second electrode branch 322 and the data line D adjacent thereto.

Along the extending direction of the scan line G, a length of the domain portion 31 of the first electrode branch 321 is the same as a length of the domain portion 31 of the second electrode branch 322.

In an example, along the extending direction of the scan line G, the space between the domain portion 31 of the first electrode branch 321 and the data line D adjacent thereto is smaller than the space between the domain portion 31 of the second electrode branch 322 and the data line D adjacent thereto. That is, compared to the domain portion 31 of the second electrode branches 322, the space between the domain portion 31 of the first electrode branch 321 and the data line D adjacent thereto is smaller. That is, the domain portion 31 of the first electrode branch 321 extends further towards a direction adjacent to the data line D adjacent thereto, so that along the extending direction of the scan line G, the length of the domain portion 31 of the first electrode branch 321 can be the same as the length of the domain portion 31 of the second electrode branch 322, and an area of the pixel electrode P10 with the first electrode branch 321 tends to the same as an area of the pixel electrode P10 without the first electrode branch 321 while the first electrode branch 321 is disconnected/discontinuous at a position corresponding to the first through-hole 41. As a result, along a direction perpendicular to a plane of the first base substrate 11, an overlapping area between each pixel electrode P10 and the common electrode tends to be the same, so that the storage capacitance of each sub-pixel P tends to be the same, thereby facilitating improving the display effect of the display panel.

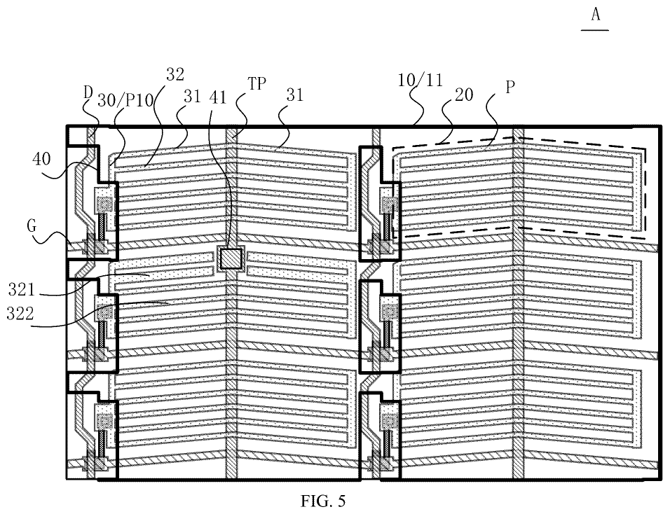

FIG. 5 is yet another enlarged view of a part A in the display panel shown in FIG. 1. Referring to FIG. 1 and FIG. 5, in some alternative embodiments, along the extending direction of the touch line TP, a width of the domain portion 31 of the first electrode branch 321 is greater than ta width of the domain portion 31 of the second electrode branch 322.

In an example, along the extending direction of the touch line TP, the width of the domain portion 31 of the first electrode branch 321 is greater than the width of the domain portion 31 of the second electrode branch 322. That is, compared to the domain portion 31 of the second electrode branch 322, the width of the domain portion 31 of the first electrode branch 321 along the extending direction of the touch line TP is greater, so that an area of the pixel electrode P10 with the first electrode branch 321 tends to be the same as an area of the pixel electrode P10 without the first electrode branch 321 while the first electrode branch 321 is disconnected/discontinuous at a position corresponding to the first through-hole 41. As a result, along the direction perpendicular to the plane of the first base substrate 11, the overlapping area of each pixel electrode P10 and the common electrode tends to be the same, so that the storage capacitance of each sub-pixel P tends to be the same, thereby facilitating improving the display effect of the display panel.

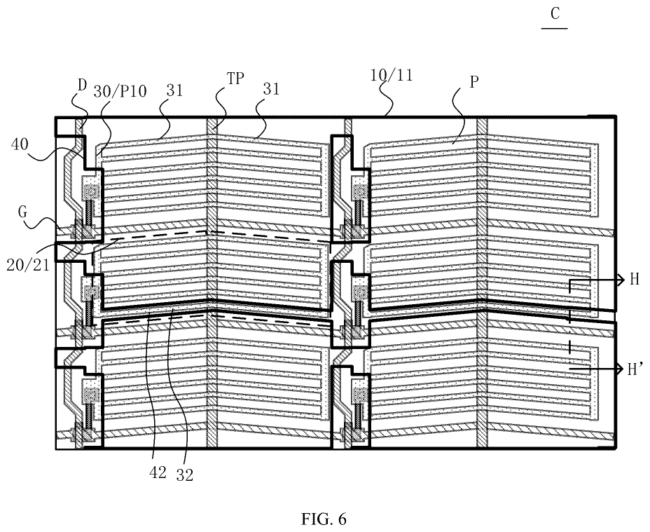

FIG. 6 is an enlarged view of a part C of the display panel shown in FIG. 1. Referring to FIG. 1 and FIG. 6, in some alternative embodiments, the touch electrodes 40 are insulated from each other, and a first gap 42 is formed between two adjacent touch electrodes 40 arranged along a column direction.

A vertical projection of the first gap 42 onto the first base substrate 11 extends through the sub-pixel region 20, and the vertical projection of the first gap 42 onto the first base substrate 11 does not overlap with a vertical projection of the scan line G onto the first base substrate 11.

In an example, the touch electrodes 40 are insulated from each other, and one touch electrode 40 is electrically connected to at least one touch line TP correspondingly. When the display panel performs touch detection, the touch lines TP provide a touch signal to the touch electrode 40 electrically connected thereto, and a detection capacitance is formed between each block-shaped touch electrode 40 and the common ground. When a touch subject, such as a finger, touches and detects the display panel, a capacitance formed between the finger and the detection capacitance is superimposed to the touch electrode 40 serving as the touch electrodes, causing a change in capacitance at the touch position, thereby obtaining the touch point coordinate based on the change in capacitance, to complete the detection of the touch position according to the touch point coordinate.

A first gap 42 is formed between two adjacent touch electrodes 40 arranged along a column direction, so that the two adjacent touch electrodes 40 arranged along the column direction are insulated from each other. One touch electrode 40 corresponds to multiple sub-pixels P, so that the vertical projection of the first gap 42 onto the first base substrate 11 extends through the sub-pixel regions 20.

An electric field formed between the scan line G and the touch electrode 40 is perpendicular to an alignment direction of the liquid crystal molecules. If the first gap 42 is arranged near the region corresponding to the scan line G, the electric field formed between the scan line G and the touch electrode 40 may leak out from the first gap 42, thereby causing the alignment direction of the liquid crystal molecules in a region corresponding to the first gap 42 to be disordered. Moreover, a space from the touch electrode 40 to the scan line G may have process fluctuations, which further cause a difference in the parasitic capacitance between the touch electrode 40 and the scan line G.

The vertical projection of the first gap 42 onto the first base substrate 11 does not overlap with the vertical projection of the scan line G onto the first base substrate 11, thereby preventing an electric field formed between the scan line G and the touch electrode 40 from leaking out from the first gap 42, preventing liquid crystal molecules corresponding to the scan line G from being deflected, thus avoiding the problem of light leakage at a position corresponding to the scan line G and improving the contrast.

Furthermore, the first gap 42 is not arranged near the region corresponding to the scan lines G, and even if the space from the touch electrode 40 to the scan line G has process fluctuations, there will be no difference in the parasitic capacitance between the touch electrode 40 and the scan line G.

For example, an angle between an extending direction of the electrode branch 32 and the alignment direction of the liquid crystal molecules is within a range from 5° to 35°. It is understandable that, in other embodiments of the present disclosure, the angle between the extending direction of the electrode branch 32 and the alignment direction of the liquid crystal molecules may be set to other angles, which will not be limited herein.

Continuing to refer to FIG. 1 and FIG. 6, in some alternative embodiments, the vertical projection of the first gap 42 onto the first base substrate 11 at least partially overlaps with the vertical projection of the electrode branch 32 onto the first base substrate 11.

In an example, the vertical projection of the first gap 42 onto the first base substrate 11 at least partially overlaps with the vertical projection of the electrode branch 32 onto the first base substrate 11, that is, the first gap 42 is arranged at a region corresponding to the electrode branch 32, so that the vertical projection of the first gap 42 onto the first base substrate 11 does not overlap with the vertical projection of the scan line G onto the first base substrate 11, that is, the first gap 42 is not arranged at the region corresponding to the scan line G, thereby avoiding the problem of light leakage at a position corresponding to the scan line G and improving the contrast. At this time, the distribution of the electric field facilitates improving a luminous efficiency of a region corresponding to the pixel electrode P10 where the electrode branch 32 is located, thereby facilitating improving a light transmittance of this region, effectively reducing an influence of the first gap 42 arranged at the position corresponding to the electrode branch 32 on the display effect of the region corresponding to the pixel electrode P10 where the electrode branch 32 is located, thus facilitating improving the display effect.

It should be noted that the vertical projection of the first gap 42 onto the first base substrate 11 may at least partially overlap with the vertical projection of any electrode branch 32 in the pixel electrode P10 onto the first base substrate 11, which may not be a limitation in the embodiments of the present disclosure, and can be configured according to actual configuration requirements.

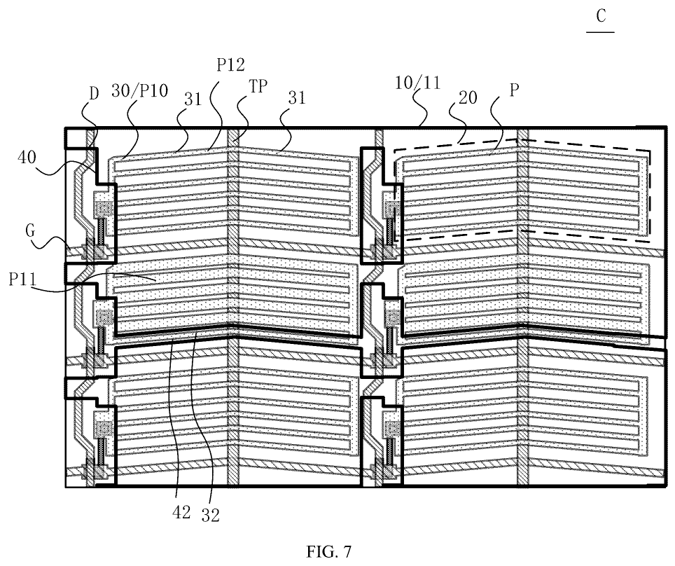

FIG. 7 is another enlarged view of a part C in the display panel shown in FIG. 1. Referring to FIG. 1 and FIG. 7, in some alternative embodiments, the pixel electrodes P10 include a first pixel electrode P11 and a second pixel electrode P12.

The vertical projection of the first gap 42 onto the first base substrate 11 at least partially overlaps with a vertical projection of the electrode branch 32 of the first pixel electrode P11 onto the first base substrate 11.

The vertical projection of the first gap 42 onto the first base substrate 11 does not overlap with a vertical projection of the electrode branch 32 of the second pixel electrode P12 onto the first base substrate 11.

Along the extending direction of the touch line TP, the width of at least part of the electrode branches 32 of the first pixel electrode P11 is greater than the width of the electrode branches 32 of the second pixel electrode P12.

In an example, the pixel electrodes P10 include the first pixel electrode P11 and the second pixel electrode P12. The vertical projection of the first gap 42 onto the first base substrate 11 at least partially overlaps with the vertical projection of the electrode branch 32 of the first pixel electrode P11 onto the first base substrate 11, that is, the first gap 42 is arranged at a region corresponding to the electrode branch 32 of the first pixel electrode P11. The vertical projection of the first gap 42 onto the first base substrate 11 does not overlap with the vertical projection of the electrode branch 32 of the second pixel electrode P12 onto the first base substrate 11, that is, the first gap 42 is not arranged at a region corresponding to the electrode branch 32 of the second pixel electrode P12.

The first gap 42 is arranged at the region corresponding to the electrode branch 32 of the first pixel electrode P11, and no first gap 42 is arranged at the region corresponding to the electrode branch 32 of the second pixel electrode P12, therefore, along a vertical direction perpendicular to a plane of the first base substrate 11, the number of the electrode branches 32 of the first pixel electrode P11 overlapping with the common electrode is less than the number of the electrode branches 32 of the second pixel electrode P12 overlapping with the common electrode, and the width of at least part of the electrode branches 32 in the first pixel electrode P11 along the extending direction of the touch line TP is greater than the width of the electrode branches 32 of the second pixel electrode P12 along the extending direction of the touch lines TP, so that along the direction perpendicular to the plane of the first base substrate 11, the overlapping area between the first pixel electrode P11 and the common electrode tends to be the same as the overlapping area between the second pixel electrode P12 and the common electrode, thus the storage capacitance of each sub-pixel P tends to be the same, thereby facilitating improving the display effect of the display panel.

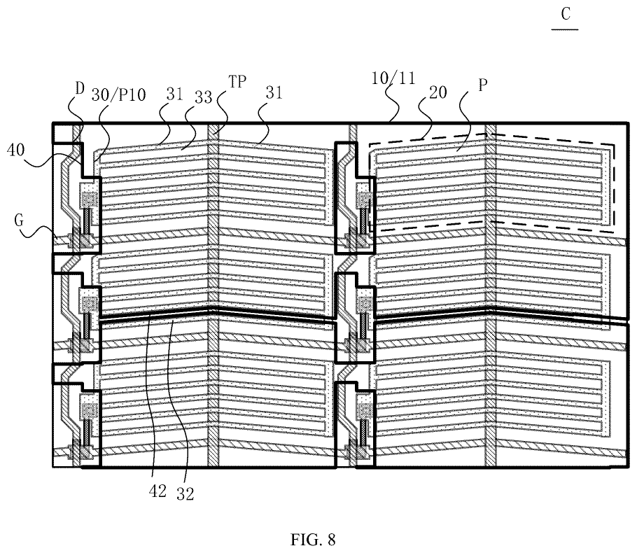

FIG. 8 is yet another enlarged view of a part C in the display panel shown in FIG. 1. Referring to FIG. 1 and FIG. 8, in some alternative embodiments, in a same pixel electrode P10, a first slit 33 is formed between two adjacent electrode branches 32.

The vertical projection of the first gap 42 onto the first base substrate 11 at least partially overlaps with a vertical projection of the first slit 33 onto the first base substrate 11.

In an example, the pixel electrode P10 includes multiple electrode branches 32 connected to each other. In a same pixel electrode P10, multiple electrode branches 32 are arranged along the extending direction of the data lines D, and the first slit 33 is formed between two adjacent electrode branches 32. The vertical projection of the first gap 42 onto the first base substrate 11 at least partially overlaps with the vertical projection of the first slit 33 onto the first base substrate 11, that is, the first gap 42 is arranged at a region corresponding to the first slit 33, so that the vertical projection of the first gap 42 onto the first base substrate 11 does not overlap with the vertical projection of the scan line G onto the first base substrate 11, that is, the first gap 42 is not is arranged at the region corresponding to the scan line G, thereby avoiding the problem of light leakage at the region corresponding to the scan line G and improving the contrast.

It should be noted that the vertical projection of the first gap 42 onto the first base substrate 11 may at least partially overlap with a vertical projection of any first slit 33 in the pixel electrode P10 onto the first base substrate 11, which will not be limited herein in the embodiments of the present disclosure, and can be configured according to actual configuration requirements.

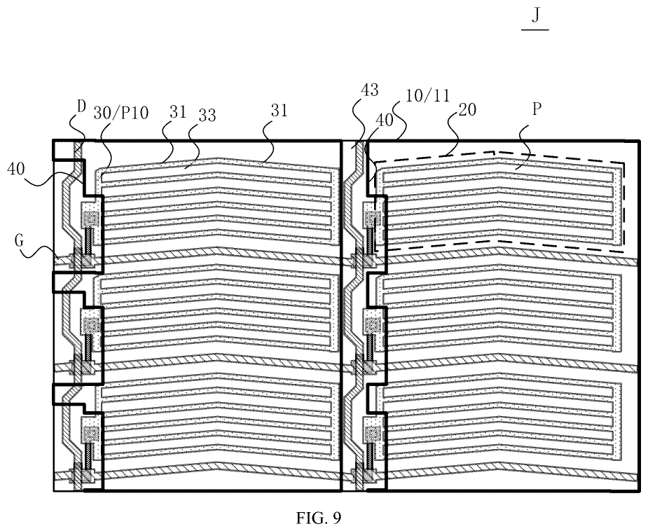

FIG. 9 is an enlarged view of a part J in the display panel shown in FIG. 1. Referring to FIG. 1 and FIG. 9, in some alternative embodiments, the touch electrodes 40 are insulated from each other, and a second gap 43 is formed between two adjacent columns of touch electrodes 40 arranged along a row direction.

The vertical projection of the second gap 43 onto the first base substrate 11 at least partially overlaps with the vertical projection of the data line D onto the first base substrate 11.

In an example, a second gap 43 is formed between two adjacent columns of touch electrodes 40 arranged along the row direction, so that two adjacent touch electrodes 40 arranged along the row direction are insulated from each other. A vertical projection of the second gap 43 onto the first base substrate 11 at least partially overlaps the vertical projection of the data line D onto the first base substrate 11, thereby effectively reducing an overlapping area between the touch electrode 40 and the data line D in a direction perpendicular to the plane of the first base substrate 11, and thus effectively reducing a parasitic capacitance between the touch electrode 40 and the data line D, and improving the display effect and touch effect of the display panel.

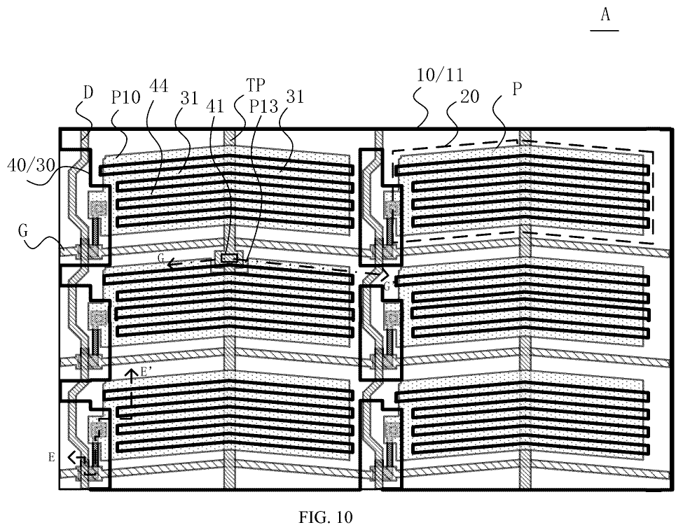

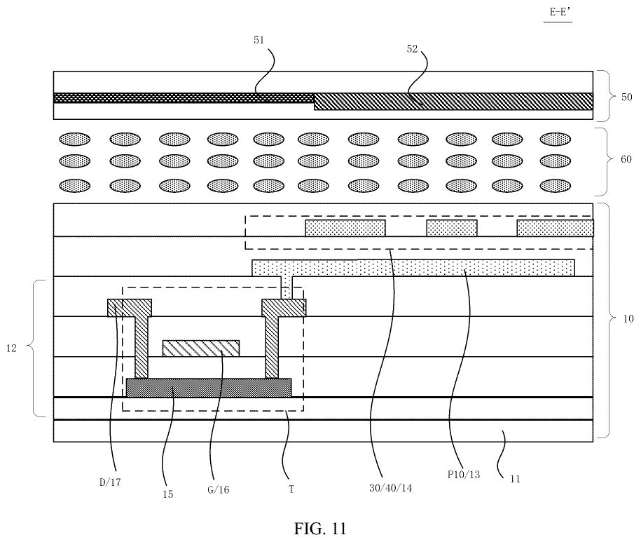

FIG. 10 is yet another enlarged view of a part A in the display panel shown in FIG. 1, and FIG. 11 is a cross-sectional view of the display panel shown in FIG. 10 along E-E′. Referring to FIG. 1, FIG. 10 and FIG. 11, in some alternative embodiments, the array substrate 10 further includes a first base substrate 11, an array layer 12, a first electrode layer 13 and a second electrode layer 14 arranged in sequence.

The scan lines G, the data lines D and the touch lines TP are arranged in the array layer 12.

The sub-pixel P further includes a pixel electrode P10 arranged in the first electrode layer 13.

The first electrode 30 is arranged in the second electrode layer 14. The first electrode 30 is the touch electrode 40, and the touch electrode 40 includes multiple electrode strips 44 connected to each other, and in a same touch electrode 40, multiple electrode strips 44 are arranged along an extending direction of the data line D.

In an example, the array substrate 10 further includes a first base substrate 11 and an array layer 12 arranged at a side of the first base substrate 11, the array layer 12 includes multiple metal film layers and an insulating layer arranged between the metal film layers, and each of the scan lines G, the data lines D and the touch lines TP is arranged in the metal film layer in the array layer 12. The array layer 12 further includes multiple thin film transistors T. Each of the gate electrodes, the source electrodes and the drain electrodes of the thin film transistors T is arranged in the metal film layer in the array layer 12, and the array layer 12 further includes an active layer 15. When the display panel according to an embodiment of the present disclosure performs display, the thin film transistor T serves as a turn on/off device of the sub-pixel P in the display panel, and is configured to transmit a pixel voltage signal to the pixel electrode P10 in a turn-on state. The gate electrode of the thin film transistor T is connected to the scan line G of the display panel, and is then connected to a scan driving circuit (not shown) via the scan line G. The source electrode of the thin film transistor T is connected to the data line D, and is then connected, via the data line D, to a driving chip or a flexible circuit board for providing a driving signal that is subsequently bound to the display panel. The drain electrode of the thin film transistor T is connected to the pixel electrode P10, and a data voltage signal is loaded to the pixel electrode P10 via the data line D, so that an electric field that drives the deflection of the liquid crystal molecules of the liquid crystal layer 60 is formed between the pixel electrode P10 and a common electrode, thereby controlling whether light is emitted or not by means of the deflection of the liquid crystal molecules, and thus achieving the display effect of the display panel. It can be understood that a display principle of the display panel is not described in detail in this embodiment. During implementation, it can be understood by referring to display principle of the liquid crystal display panel in the related art.

The array substrate 10 further includes a first electrode layer 13 and a second electrode layer 14 arranged at a side of the first electrode layer 13 away from the first base substrate 11. The pixel electrode P10 is arranged in the first electrode layer 13, and the first electrode layer 13 may be understood as a pixel electrode layer. The first electrode 30 is the touch electrode 40, and the touch electrode 40 is arranged in the second electrode layer 14. When the display panel is at the display stage, the touch electrode 40 is configured to access a common voltage signal, that is, the touch electrode 40 may be understood as the common electrode. The pixel electrode P10 is arranged between the first base substrate 11 and the touch electrode 40, so that the pixel electrode P10 is designed as a block shape. The touch electrode 40 includes multiple electrode strips 44 connected to each other. In a same touch electrode 40, the electrode strips 44 are arranged along the extending direction of the data line D, so that when the display panel is at the display stage, the electric field formed between the touch electrode 40 and the pixel electrode P10 may exit from a slit between the electrode strips 44, thereby driving the liquid crystal molecules of the liquid crystal layer 60 to deflect, and achieving the display effect of the display panel.

Continuing to refer to FIG. 1, FIG. 10 and FIG. 11, in some alternative embodiments, a vertical projection of the electrode strips 44 onto the first base substrate 11 at least partially overlaps with the vertical projection of the first through-hole 41 onto the first base substrate 11.

In an example, the vertical projection of the electrode strips 44 onto the first base substrate 11 at least partially overlaps with the vertical projection of the first through-hole 41 onto the first base substrate 11, that is, along the vertical projection perpendicular to the plane of the first base substrate 11, the first through-hole 41 at least partially overlaps with the electrode strip 44, that is, the first through-hole 41 is arranged at a region corresponding to the electrode strip 44, so that the touch lines TP and the touch electrode 40 corresponding thereto are electrically connected via the first through-hole 41.

Continuing to refer to FIG. 1, FIG. 10 and FIG. 11, in some alternative embodiments, at least one pixel electrode P10 includes a first groove P13. The vertical projection of the first through-hole 41 onto the first base substrate 11 at least partially overlaps with a vertical projection of the first groove P13 onto the first base substrate 11, and the vertical projection of the first through-hole 41 onto the first base substrate 11 does not overlap with the vertical projection of the pixel electrode P10 onto the first base substrate 11.

In an example, the pixel electrode P10 is arranged between the first base substrate 11 and the touch electrodes 40, and the touch line TP is arranged in the metal film layer in the array layer 12. The touch electrode 40 is electrically connected to the corresponding touch line TP via the first through-hole 41. The vertical projection of the first through-hole 41 onto the first base substrate 11 at least partially overlaps with the vertical projection of the first groove P13 onto the first base substrate 11, that is, the first groove P13 is arranged at the pixel electrode P10 corresponding to the first through-hole 41, so that the vertical projection of the first through-hole 41 onto the first base substrate 11 does not overlap with the vertical projection of the pixel electrode P10 onto the first base substrate 11, and the arrangement of the pixel electrode P10 and the arrangement of the first through-hole 41 do not affect each other.

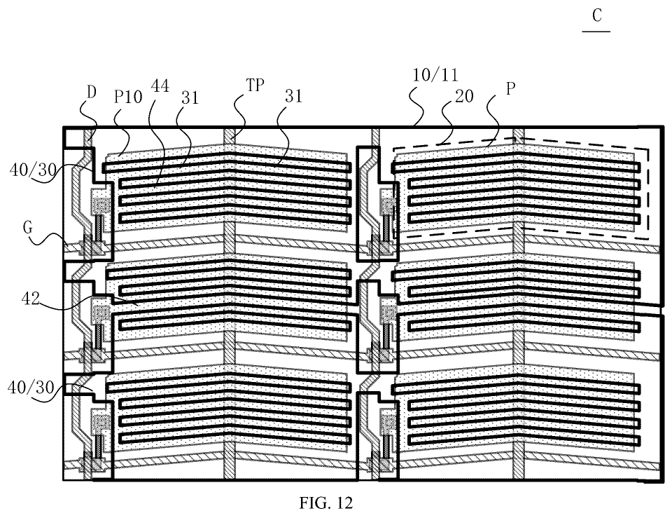

FIG. 12 is yet another enlarged view of a part C in the display panel shown in FIG. 1. Referring to FIG. 1 and FIG. 12, in some alternative embodiments, the touch electrodes 40 are insulated from each other. A first gap 42 is formed between two adjacent touch electrodes 40 arranged along the column direction, and the first gap 42 is arranged between two adjacent electrode strips 44.

A vertical projection of the first gap 42 onto the first base substrate 11 extends through the sub-pixel region 20, and the vertical projection of the first gap 42 onto the first base substrate 11 does not overlap with a vertical projection of the scan line G onto the first base substrate 11.

In an example, the touch electrodes 40 are insulated from each other, and one touch electrode 40 is electrically connected to at least one touch line TP correspondingly. When the display panel performs touch detection, the touch lines TP provide a touch signal to the touch electrode 40 electrically connected thereto, and a detection capacitance is formed between each block-shaped touch electrode 40 and the common ground. When a touch subject, such as a finger, touches and detects the display panel, a capacitance formed between the finger and the detection capacitance is superimposed to the touch electrode 40 serving as the touch electrode, thereby forming a touch point coordinate, to complete the detection of the touch position according to the touch point coordinates.

A first gap 42 is formed between two adjacent touch electrodes 40 arranged along the column direction, and the first gap 42 is arranged between two adjacent electrode strips 44, so that two adjacent touch electrodes 40 arranged along the column direction are insulated from each other. One touch electrode 40 corresponds to multiple sub-pixels P, so that the vertical projection of the first gap 42 onto the first base substrate 11 extends through the sub-pixel region 20. The vertical projection of the first gap 42 onto the first base substrate 11 does not overlap with the vertical projection of the scan line G onto the first base substrate 11, thereby preventing an electric field formed between the scan line G and the touch electrode 40 from leaking out from the first gap 42, and thus preventing liquid crystal molecules corresponding to the scan line G from being deflected, avoiding the problem of light leakage at a position corresponding to the scan line G, and improving the contrast.

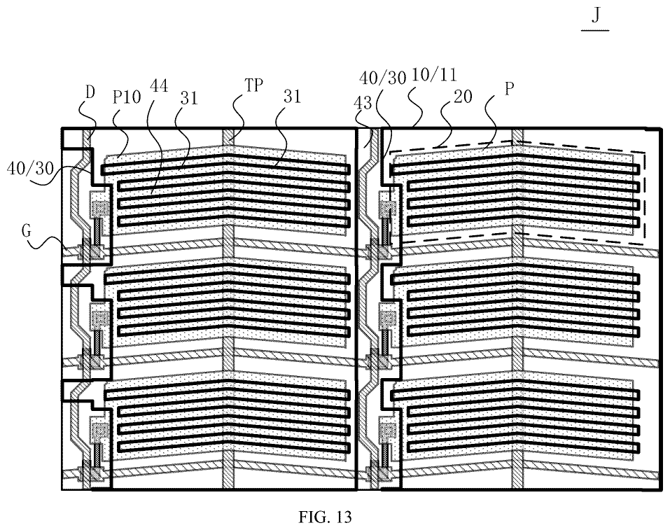

FIG. 13 is another enlarged view of a part J in the display panel shown in FIG. 1. Referring to FIG. 1 and FIG. 13, in some alternative embodiments, the touch electrodes 40 are insulated from each other, and a second gap 43 is formed between two adjacent columns of touch electrodes 40 arranged along a row direction.

The vertical projection of the second gap 43 onto the first base substrate 11 at least partially overlaps with the vertical projection of the data line D onto the first base substrate 11.

In an example, a second gap 43 is formed between two adjacent columns of touch electrodes 40 arranged along the row direction, so that two adjacent touch electrodes 40 arranged along the row direction are insulated from each other. A vertical projection of the second gap 43 onto the first base substrate 11 at least partially overlaps the vertical projection of the data line D onto the first base substrate 11, thereby effectively reducing an overlapping area between the touch electrode 40 and the data line D in a direction perpendicular to the plane of the first base substrate 11, and thus effectively reducing a parasitic capacitance between the touch electrode 40 and the data line D, and improving the display effect and touch effect of the display panel.

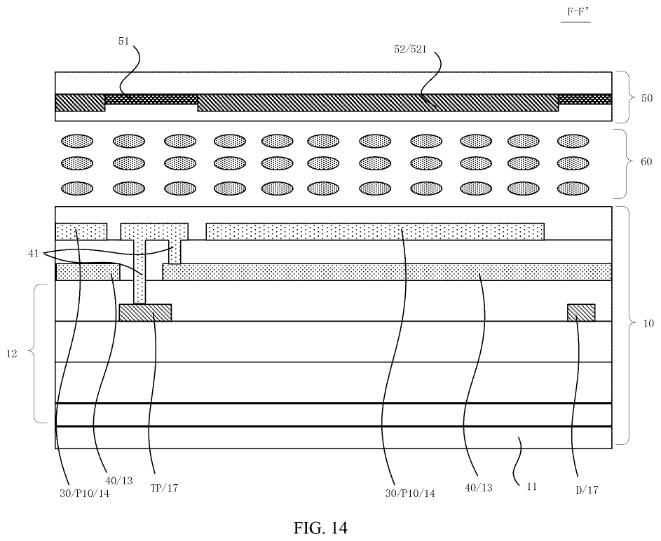

FIG. 14 is a cross-sectional view of the display panel shown in FIG. 2 along F-F′. Referring to FIG. 1, FIG. 2, FIG. 3 and FIG. 14, in some alternative embodiments, the array substrate 10 further includes a first base substrate 11 and an array layer 12 arranged at a side of the first base substrate 11.

The array layer 12 further includes a first metal layer 16 and a second metal layer 17 arranged at a side of the first metal layer 16 away from the first substrate 11.

The scan lines G are arranged in the first metal layer 16, and the data lines D and the touch lines TP are arranged in the second metal layer 17.

In an example, the array substrate 10 further includes a first base substrate 11 and an array layer 12 arranged at a side of the first base substrate 11, and the array layer 12 includes a first metal layer 16 and a second metal layer 17. The first metal layer 16 is arranged between the first base substrate 11 and the second metal layer 17, the scan lines G are arranged in the first metal layer 16, and the data lines D and the touch lines TP are arranged in the second metal layer 17. In other words, the touch lines TP and the data lines D in this embodiment may be arranged in the same layer, and the manufacturing of the touch lines TP and the data lines D in a same layer may be completed using one mask plate processing process, thereby facilitating saving the cost, simplifying the manufacturing process, and reducing the thickness of the display panel. It can be understood that the array substrate 10 of this embodiment may further include other metal film layer, which will not be described in detail in this embodiment, and can be understood by referring to the structure of the liquid crystal display panel in the related art.

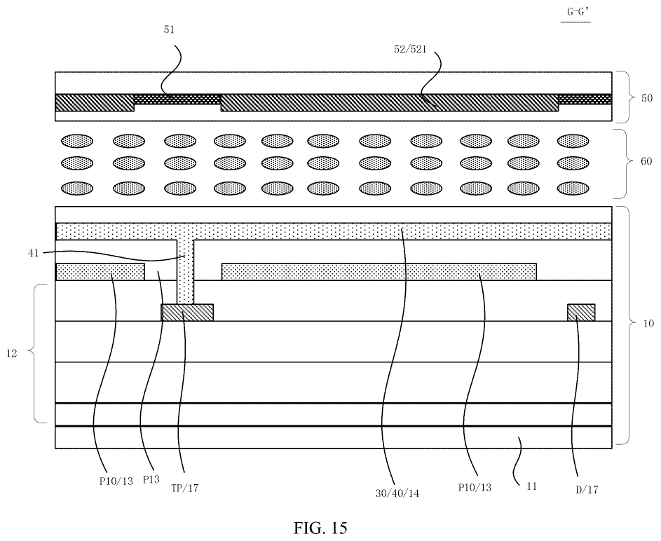

It should be noted that, when the data lines D and the touch lines TP are arranged in a same layer, and the touch electrode 40 in the display panel is arranged between the pixel electrode P10 and the first base substrate 11, the structure of the first through-hole 41 may be configured with reference to FIG. 14. In other embodiments of the present disclosure, when the pixel electrode P10 is arranged between the touch electrode 40 and the first base substrate 11, the structure of the first through-hole 41 may be configured with reference to FIG. 15, which is a cross-sectional view of the display panel shown in FIG. 10 along G-G′.

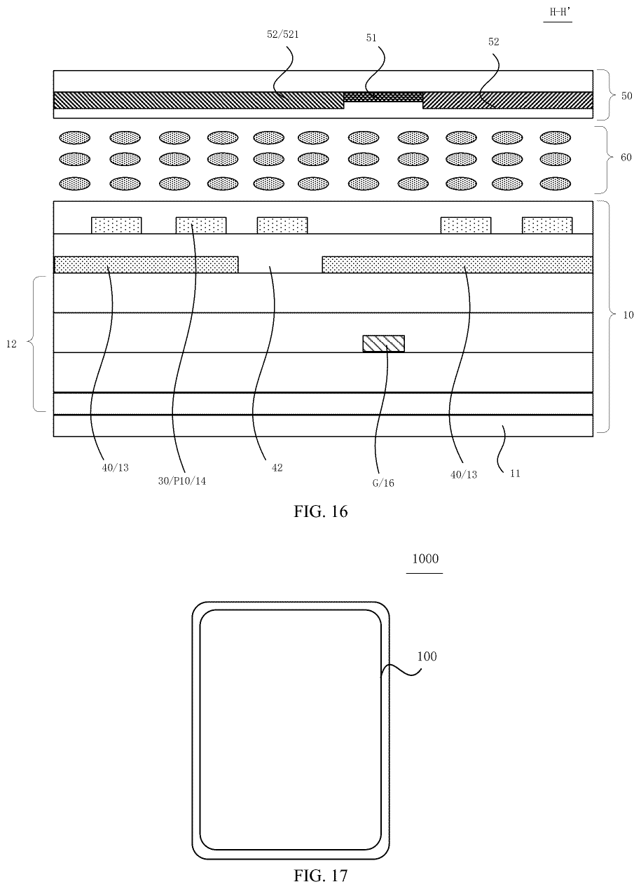

FIG. 16 is a cross-sectional view of the display panel of FIG. 6 along H-H′. Referring to FIG. 1, FIG. 6 and FIG. 16, in some alternative embodiments, the display panel further includes a color filter substrate 50 arranged opposite to the array substrate 10. The color filter substrate 50 includes a light shielding portion 51 and color resists 52, and the light shielding portion 51 includes openings. The openings one-to-one correspond to the sub-pixel regions 20, the color resists 52 one-to-one correspond to the openings, and the color resists 52 are at least partially arranged in the openings corresponding thereto.

The color resists 52 include a blue color resist 521, and the sub-pixel regions 20 include a first sub-pixel region 21 corresponding to the blue color resist 521.

The vertical projection of the first gap 42 onto the first base substrate 11 extends through the first sub-pixel region 21.

In an example, the display panel further includes a color filter substrate 50 arranged opposite to the array substrate 10. The color filter substrate 50 includes a light shielding portion 51 and color resists 52, and the light shielding portion 51 includes openings. The openings one-to-one correspond to the sub-pixel regions 20, the color resists 52 one-to-one correspond to the openings, and the color resists 52 are at least partially arranged in the openings corresponding thereto. A vertical projection of the scan lines G, the data lines D, and the touch lines TP onto the first base substrate 11 is located in a vertical projection of the light shielding portion 51 onto the first base substrate 11, that is, the light shielding portion 51 can shield the scan lines G, the data lines D, the touch lines TP, and the thin film transistor structures, thereby preventing the metal structure from reflecting light and possibly causing disordered alignment of these structures to affect the display quality.

Meanwhile, the color filter substrate 50 includes color resists 52 of multiple colors, and the arrangement of the light shielding portion 51 between the color resists 52 of different colors can avoid the problem of color mixing between the sub-pixels P of different colors.

The color resists 52 include a blue color resist 521, and the sub-pixel regions 20 include a first sub-pixel region 21 corresponding to the blue color resist 521, that is, a sub-pixel P corresponding to the first sub-pixel region 21 is a blue sub-pixel. The vertical projection of the first gap 42 onto the first base substrate 11 extends through the first sub-pixel region 21, that is, the first gap 42 is arranged at a region corresponding to the blue sub-pixel. The arrangement of the first gap 42 may cause a loss of transmittance of the sub-pixel P corresponding to the first gap 42. Since the blue sub-pixel has a minimum contribution to brightness when the display panel performs displaying, the first gap 42 is arranged at a region corresponding to the blue sub-pixel, so that the loss of transmittance has a minimum influence on the display effect of the display panel.

Referring to FIG. 1, FIG. 2 and FIG. 14, in some alternative embodiments, the display panel further includes a color filter substrate 50 arranged opposite to the array substrate 10. The color filter substrate 50 includes a light shielding portion 51 and color resists 52, and the light shielding portion 51 includes openings. The openings one-to-one correspond to the sub-pixel regions 20, the color resists 52 one-to-one correspond to the openings, and the color resists 52 are at least partially arranged in the openings corresponding thereto.

The color resists 52 include a blue color resist 521, and the sub-pixel regions 20 include a first sub-pixel region 21 corresponding to the blue color resist 521.

The vertical projection of the first through-hole 41 onto the array substrate 10 is located in the first sub-pixel region 21.

In an example, the display panel further includes a color filter substrate 50 arranged opposite to the array substrate 10. The color filter substrate 50 includes a light shielding portion 51 and color resists 52, and the light shielding portion 51 includes openings. The openings one-to-one correspond to the sub-pixel regions 20, the color resists 52 one-to-one correspond to the openings, and the color resists 52 are at least partially arranged in the openings corresponding thereto. A vertical projection of the scan lines G, the data lines D, and the touch lines TP onto the first base substrate 11 is located in a vertical projection of the light shielding portion 51 onto the first base substrate 11, that is, the light shielding portion 51 can shield the scan lines G, the data lines D, the touch lines TP, and the thin film transistor structure, thereby preventing the metal structure from reflecting light to affect the display quality.

Meanwhile, the color filter substrate 50 includes color resists 52 of multiple colors, and the arrangement of the light shielding portion 51 between the color resists 52 of different colors can avoid the problem of color mixing between the sub-pixels P of different colors.

The color resists 52 include a blue color resist 521, and the sub-pixel regions 20 include a first sub-pixel region 21 corresponding to the blue color resist 521, that is, a sub-pixel P corresponding to the first sub-pixel region 21 is a blue sub-pixel. The vertical projection of the first through-hole 41 onto the array substrate 10 is located in the first sub-pixel region 21, that is, the first through-hole 41 is arranged at a region corresponding to the blue sub-pixel. The arrangement of the first through-hole 41 may cause a loss of transmittance of the sub-pixel P corresponding to the first through-hole 41. Since the blue sub-pixel has a minimum contribution to brightness when the display panel performs displaying, the first through-hole 41 is arranged at a region corresponding to the blue sub-pixel, so that the loss of transmittance has a minimum influence on the display effect of the display panel.

For example, a first sub-pixel region 21 corresponding to the first through-hole 41 and a first sub-pixel region 21 corresponding to the first gap 42 are not a same first sub-pixel region 21, that is, the first through-hole 41 and the first gap 42 are not provided at a same first sub-pixel region 21, thereby avoiding causing a larger loss of the transmittance of a certain blue sub-pixel to affect the display effect. Meanwhile, it can avoid that the arrangement of the first through-hole 41 increases a risk of connection between the touch electrodes 40 at two sides of the first gap 42.

Referring to FIG. 1, FIG. 2 and FIG. 14, in some alternative embodiments, the display panel further includes a color filter substrate 50 arranged opposite to the array substrate 10. The color filter substrate 50 includes a light shielding portion 51 and color resists 52, and the light shielding portion 51 includes openings. The openings one-to-one correspond to the sub-pixel regions 20, the color resists 52 one-to-one correspond to the openings, and the color resists 52 are at least partially arranged in the openings corresponding thereto.

The vertical projection of the first through-hole 41 onto the array substrate 10 at least partially overlaps with a vertical projection of the light shielding portion 51 onto the array substrate 10.

In an example, the display panel further includes a color filter substrate 50 arranged opposite to the array substrate 10. The color filter substrate 50 includes a light shielding portion 51 and color resists 52, and the light shielding portion 51 includes openings. The openings one-to-one correspond to the sub-pixel regions 20, the color resists 52 one-to-one correspond to the openings, and the color resists 52 are at least partially arranged in the openings corresponding thereto. A vertical projection of the scan lines G, the data lines D, and the touch lines TP onto the first base substrate 11 is located in a vertical projection of the light shielding portion 51 onto the first base substrate 11, that is, the light shielding portion 51 can shield the scan lines G, the data lines D, the touch lines TP, and the thin film transistor structure, thereby preventing the metal structure from reflecting light to affect the display quality.

Meanwhile, the color filter substrate 50 includes color resists 52 of multiple colors, and the arrangement of the light shielding portion 51 between the color resists 52 of different colors can avoid the problem of color mixing between the sub-pixels P of different colors.

The vertical projection of the first through-hole 41 onto the array substrate 10 at least partially overlaps with the vertical projection of the light shielding portion 51 onto the array substrate 10, so that the light shielding portion 51 can shield part of the touch lines TP that is electrically connected to the first through-hole 41, thereby avoiding light leakage at a position corresponding to the first through-hole 41 and improving the contrast.

Furthermore, the light shielding portion 51 needs to be arranged both at a position corresponding to the first through-hole 41 and at a position corresponding to the scan line G, and the first through-hole 41 and the scan line G are arranged adjacent to each other, therefore, the light shielding portion 51 arranged at the position corresponding to the first through-hole 41 can be reused as the light shielding portion 51 arranged at the position corresponding to the scan lines G adjacent thereto, thereby effectively reducing an influence of the light shielding portion 51 arranged at the position corresponding to the first through-hole 41 on the aperture ratio.

As shown in FIG. 17, FIG. 17 is a schematic plan view of a display device according to an embodiment of the present disclosure. An embodiment of the present disclosure further provides a display device 1000, including the display panel 100 provided by any one of the above-mentioned embodiments. The embodiment provided in FIG. 17 only takes a mobile phone as an example to illustrate the display device. It can be understood that the display device provided by the embodiments of the present disclosure may be any electronic product with a display function, including but not limited to the following categories: a cellphone, a television, a laptop, a desktop display, a tablet computer, a digital camera, a smart bracelet, smart glasses, a vehicle-mounted display, a medical device, an industrial control device, a touch interactive terminal, and the like, which will not be limited herein in the embodiments of the present disclosure.

The display device 1000 provided by the embodiments of the present disclosure has the same technical features as the display panel 100 provided by the above-mentioned embodiments of the present disclosure, to solve the same technical problems and achieving the same technical effects.

It should be noted that, in this context, relational terms such as “first” and “second” are merely used to distinguish one entity or operation from another entity or operation, and do not necessarily require or imply any actual relationship or sequence between these entities or operations. In addition, terms such as “include”, “comprise” or any other variations thereof are intended to cover a non-exclusive inclusion, thus a process, method, item or device including a series of elements include not only those elements, but also other elements not explicitly listed, or elements inherent in such process, method, item or device. Without more limitations, an element defined by the expression “including a/one” does not preclude the presence of another identical element in a process, method, article, or device that includes this a/one element.

The above description only describes some embodiments of the present disclosure, for the purpose of that those skilled in the art can understand or implement the present disclosure. Various modifications to these embodiments will be apparent to those skilled in the art, and the general principles defined herein may be implemented in other embodiments without departing from the scope of the present disclosure. Accordingly, the present disclosure will not be limited to the embodiments described herein, but should be interpreted to have the broadest scope in conformity with the principles and innovations disclosed in the present disclosure.

What is claimed is:

1. A display panel, comprising an array substrate,
wherein the array substrate comprises:
scan lines and data lines intersecting each other in an insulated manner to define sub-pixel regions;
sub-pixels arranged in an array, wherein at least one of the sub-pixels is provided within a respective one of the sub-pixel regions, each of the sub-pixels comprises a first electrode, the first electrodes comprise two domain portions having different domain orientations along an extending direction of one of the scan lines, and domain boundaries of a column of first electrodes are arranged at a same straight line;
touch lines, wherein an extending direction of one of the touch lines is the same as an extending direction of the domain boundaries of a column of first electrodes, and a vertical projection of the one of the touch lines onto the array substrate at least partially overlaps with a vertical projection of the domain boundaries of the column of first electrodes onto the array substrate; and
touch electrodes, wherein one of the touch electrodes is electrically connected to at least one of the touch lines via a first through-hole, a vertical projection of the first through-hole onto the array substrate at least partially overlaps with a vertical projection of the touch line onto the array substrate, and the first through-hole is arranged adjacent to the scan line.

2. The display panel according to claim 1, wherein
the array substrate further comprises a first base substrate, an array layer, a first electrode layer, and a second electrode layer;
the scan lines, the data lines and the touch lines are arranged in the array layer;
the touch electrodes are arranged in the first electrode layer;
the first electrodes are arranged in the second electrode layer; and
one of the sub-pixels comprises a pixel electrode, the first electrode is the pixel electrode, the pixel electrode comprises electrode branches connected to each other, and the electrode branches of a same pixel electrode are arranged along an extending direction of one of the data lines.

3. The display panel according to claim 2, wherein
the electrode branches comprise a first electrode branch and a second electrode branch;
in the first electrode branch, the two domain portions are arranged at two sides of the first through-hole along the extending direction of one of the scan lines, and a vertical projection of the two domain portions onto the first base substrate is discontinuous at a position corresponding to the vertical projection of the first through-hole onto the first base substrate; and
a vertical projection of the second electrode branch onto the first base substrate partially overlaps with the vertical projection of one of the touch lines onto the first base substrate.

4. The display panel according to claim 3, wherein
along the extending direction of one of the scan lines, a space between the domain portion of the first electrode branch and the data line adjacent thereto is smaller than a space between the domain portion of the second electrode branch and the data line adjacent thereto; and
along the extending direction of one of the scan lines, a length of the domain portion of the first electrode branch is the same as a length of the domain portion of the second electrode branch.

5. The display panel according to claim 3, wherein
along the extending direction of one of the touch lines, a width of the domain portion of the first electrode branch is greater than a width of the domain portion of the second electrode branch.

6. The display panel according to claim 2, wherein
the touch electrodes are insulated from each other, and a first gap is formed between two adjacent touch electrodes arranged in a column direction; and
a vertical projection of the first gap onto the first base substrate extends through the sub- pixel region, and the vertical projection of the first gap onto the first base substrate does not overlap with the vertical projection of the scan line onto the first base substrate.

7. The display panel according to claim 6, wherein
the vertical projection of the first gap onto the first base substrate at least partially overlaps the vertical projection of the electrode branch onto the first base substrate.

8. The display panel according to claim 7, wherein
the pixel electrodes comprise a first pixel electrode and a second pixel electrode;
the vertical projection of the first gap onto the first base substrate at least partially overlaps with a vertical projection of the electrode branch of the first pixel electrode onto the first base substrate;
the vertical projection of the first gap onto the first base substrate does not overlap with a vertical projection of the electrode branch of the second pixel electrode onto the first base substrate; and
a width of at least part of the electrode branches of the first pixel electrode is greater than a width of the electrode branches of the second pixel electrode along the extending direction of one of the touch lines.

9. The display panel according to claim 6, wherein
in a same pixel electrode, a first slit is formed between two adjacent electrode branches; and
a vertical projection of the first gap onto the first base substrate at least partially overlaps with a vertical projection of the first slit onto the first base substrate.

10. The display panel according to claim 1, wherein
the array substrate further comprises a first base substrate, an array layer, a first electrode layer, and a second electrode layer;
the scan lines, the data lines and the touch lines are arranged in the array layer;
one of the sub-pixels further comprises a pixel electrode arranged in the first electrode layer; and
the first electrode is arranged in the second electrode layer, the first electrode is the touch electrode, the touch electrode comprises electrode strips connected to each other, and the electrode strips of a same touch electrode are arranged along the extending direction of one of the data lines.

11. The display panel according to claim 10, wherein
a vertical projection of the electrode strip onto the first base substrate at least partially overlaps with the vertical projection of the first through-hole onto the first base substrate.

12. The display panel according to claim 10, wherein
at least one pixel electrode comprises a first groove, the vertical projection of the first through-hole onto the first base substrate at least partially overlaps with a vertical projection of the first groove onto the first base substrate, and the vertical projection of the first through-hole onto the first base substrate does not overlap with the vertical projection of the pixel electrode onto the first base substrate.

13. The display panel according to claim 10, wherein
the touch electrodes are insulated from each other, a first gap is formed between two adjacent touch electrodes arranged in a column direction, and the first gap is arranged between two adjacent electrode strips; and
a vertical projection of the first gap onto the first base substrate extends through the sub-pixel region, and the vertical projection of the first gap onto the first base substrate does not overlap with the vertical projection of the scan line onto the first base substrate.

14. The display panel according to claim 2, wherein
the touch electrodes are insulated from each other, and a second gap is formed between two adjacent columns of the touch electrodes arranged in a row direction; and
a vertical projection of the second gap onto the first base substrate at least partially overlaps with the vertical projection of one of the data lines onto the first base substrate.

15. The display panel according to claim 10, wherein
the touch electrodes are insulated from each other, and a second gap is formed between two adjacent columns of the touch electrodes arranged in a row direction; and
a vertical projection of the second gap onto the first base substrate at least partially overlaps with the vertical projection of one of the data lines onto the first base substrate.

16. The display panel according to claim 1, wherein
the array substrate further comprises a first base substrate and an array layer arranged at a side of the first base substrate;
the array layer further comprises a first metal layer, and a second metal layer that is arranged at a side of the first metal layer away from the first base substrate; and
the scan lines are arranged in the first metal layer, and the data lines and the touch lines are arranged in the second metal layer.

17. The display panel according to claim 6, further comprising a color filter substrate arranged opposite to the array substrate,
wherein the color filter substrate comprises a light shielding portion and color resists, the light shielding portion comprises openings, the openings one-to-one correspond to the sub-pixel regions, the color resists one-to-one correspond to the openings, and the color resists are at least partially arranged in the openings corresponding thereto;
wherein the color resists comprise a blue color resist, the sub-pixel regions comprise a first sub-pixel region arranged corresponding to the blue color resist; and
wherein the vertical projection of the first gap onto the first base substrate extends through the first sub-pixel region.

18. The display panel according to claim 13, further comprising a color filter substrate arranged opposite to the array substrate,
wherein the color filter substrate comprises a light shielding portion and color resists, the light shielding portion comprises openings, the openings one-to-one correspond to the sub-pixel regions, the color resists one-to-one correspond to the openings, and the color resists are at least partially arranged in the openings corresponding thereto;
wherein the color resists comprise a blue color resist, the sub-pixel regions comprise a first sub-pixel region arranged corresponding to the blue color resist; and
wherein the vertical projection of the first gap onto the first base substrate extends through the first sub-pixel region.

19. The display panel according to claim 1, further comprising a color filter substrate arranged opposite to the array substrate,
wherein the color filter substrate comprises a light shielding portion and color resists, the light shielding portion comprises openings, the openings one-to-one correspond to the sub-pixel regions, the color resists one-to-one correspond to the openings, and the color resists are at least partially arranged in the openings corresponding thereto; and
wherein the color resists comprise a blue color resist, the sub-pixel regions comprise a first sub-pixel region arranged corresponding to the blue color resist; and the vertical projection of the first through-hole onto the array substrate is arranged in the first sub-pixel region; or wherein the vertical projection of the first through-hole onto the array substrate at least partially overlaps with a vertical projection of the light shielding portion onto the array substrate.

20. A display device, comprising a display panel comprising an array substrate,
wherein the array substrate comprises:
scan lines and data lines intersecting each other in an insulated manner to define sub-pixel regions;
sub-pixels arranged in an array, wherein at least one of the sub-pixels is provided within a respective one of the sub-pixel regions, each of the sub-pixels comprises a first electrode, the first electrodes comprise two domain portions having different domain orientations along an extending direction of one of the scan lines, and domain boundaries of a column of first electrodes are arranged at a same straight line;
touch lines, wherein an extending direction of one of the touch lines is the same as an extending direction of the domain boundaries of a column of first electrodes, and a vertical projection of the one of the touch lines onto the array substrate at least partially overlaps with a vertical projection of the domain boundaries of the column of first electrodes onto the array substrate; and
touch electrodes, wherein one of the touch electrodes is electrically connected to at least one of the touch lines via a first through-hole, a vertical projection of the first through-hole onto the array substrate at least partially overlaps with a vertical projection of the touch line onto the array substrate, and the first through-hole is arranged adjacent to the scan line.
